(19) United States
(12) Patent Application Publication
(10) Pub. No.: US 2015/0116991 A1
(43) Pub. Date: Apr. 30, 2015

(54) Multi-function and portable device for forming separately an illuminator and a barrier and for forming in combination an illuminated barrier

(71) Applicant: Henry Miano, Stony Brook, NY (US)

(72) Inventor: Henry Miano, Stony Brook, NY (US)

(21) Appl. No.: 13/998,379

(22) Filed: Oct. 28, 2013

(51) Int. Cl. E01F 9/016; F21L 4/00; E01F 9/012

(52) U.S. Cl. CPC E01F 9/016; E01F 9/0122; F21L 4/00
USPC 362/157

(57) ABSTRACT

A multi-function and portable device forming separately an illuminator and a barrier and forming in combination an illuminated barrier. The multi-function and portable device includes a traffic cone and a hand-held light wand. The hand-held light wand extends replaceably from the traffic cone without a need for cone adaptors so as to allow the hand-held light wand and the traffic cone to operate separately of each other and act as the illuminator and the barrier, respectively, and to act in combination with each other so as to form the illuminated barrier.

### 1. BACKGROUND OF THE INVENTION

A. Field of the Invention

The embodiments of the present invention relate to an illuminated barrier, and more particularly, the embodiments of the present invention relate to a multi-function and portable device for forming separately an illuminator and a barrier and for forming in combination an illuminated barrier.

B. Description of the Prior Art

Traffic cones are used for a variety of traffic control purposes, for example, to warn drivers of the presence of roadworks, and to direct the flow of traffic along preferred lines. To carry out their functions properly, the cones must be clearly visible even at night and under adverse weather conditions, and to this end they are frequently provided with one or more light reflecting surfaces that reflect light from the headlamps of oncoming vehicles. When reflection of light is insufficient, it is common to position a warning light on the traffic cone.

The warning light includes a battery housing and a head projecting upwardly therefrom. The head contains a lamp powered by a battery in the battery housing and a lens for controlling the direction in which light from the lamp is transmitted as a substantially unidirectional beam in a single or in two opposite and parallel directions.

It is evident, considering the profusion of traffic cones on motorways, that only the simplest systems for mounting the warning light on the traffic cone are practicable. In one such known mounting system, the battery housing is mounted on a circular bracket cone adaptor that may be positioned as a collar around the conical neck of a traffic cone. Thus, in use with the collar located on the neck of the traffic cone, the battery housing and head of the warning light are presented at one side of the cone.

This known mounting system has been employed on roads worldwide, but it suffers from a number of disadvantages. One is its mechanical instability. The weight of the warning light when fitted with a battery is normally comparable with that of the traffic cone on the side of which the warning light is supported. Thus, the warning light tends to destabilize the traffic cone. Furthermore, the exposed head of the warning light is liable to be caught by high winds. The possible consequences of the cone or warning light being knocked over are all too obvious. The warning light may be damaged as it hits the ground. The disappearance of the light will result in hazardous areas being insufficiently marked out, and above all, the traffic cone and warning light may fall into the path of traffic, thus creating a new and highly significant traffic hazard.

Roadworkers who fit warning lights onto traffic cones have noticed the instability of this known mounting system, and as a result, frequently attempt to make the head of the warning light less exposed by fitting the warning light upside down on the traffic cone, that is, with the head projecting downwardly beneath the battery housing. This makes the warning light less visible and misdirects the beam from the optimum direction for maximum effectiveness. Furthermore, many designs of warning lights are such that when positioned upside down in this way, they have a disadvantageous tendency to collect rainwater within the head.

Another feature of the known warning light described above is that the battery is generally retained inside the battery housing by a mechanism in which screwthreaded elements are used either to connect the battery directly to the housing or to hold together elements that enclose the battery. These screw-threaded elements must be laboriously removed and repositioned whenever a battery is renewed. To prevent theft of the battery, the screw-threaded elements are usually locked in position so that a key is needed to remove them. This is despite the fact that in many environments, for example in motorways, the theft of batteries from warning lights would be uncommon even if their battery housings were not locked.

Referring now to the figures of the drawing in which like numerals indicate like parts, and particularly to FIG. 1, which is a diagrammatic perspective view of prior art traffic cones in use forming a barrier, a prior art traffic cone is shown generally at 10.

The configuration of the prior art traffic cone 10 can best be seen in FIG. 2, which is an enlarged diagrammatic perspective view of a prior art traffic cone identified by ARROW 2 in FIG. 1, and as such, will be discussed with reference thereto.

The prior art traffic cone 10 comprises a conical body 12 and a base 14. The conical body 12 extends upwardly from the base 14, is hollow and upwardly tapering, and has an open bottom 16 and an open top 18. The base 14 is flat, and extends radially outwardly from the open bottom 16 of the conical body 12.

Visual signaling is a common and easily understood method of relaying information from at least one person to another. Visual signaling is often used in environments hostile to other forms of communication. Such environments include traffic intersections, airports, mountain ranges, underwater, and the like. Provided the environment is hospitable to the transmission of light from a source point to a receiver point, visual signaling provides an effective way of communication. Such environments, however, tend to be destructive on the visual signaling device.

One type of visual signaling device is a light baton or wand. Light batons or wands are hand-held devices that at the control of the holder emit colored and white light. Light batons or wands are used to direct pedestrians, motor vehicles, aviation vehicles, and the like. The baton or wand may be used to generate light signals indicating safe and clear passage, dangerous and hazardous conditions, direction to proceed, or identifying one location.

A light baton or wand is hand-held, and therefore, requires a human being to hold it. This makes the light baton or wand limited as to its uses.

As shown in FIG. 3, which is a diagrammatic perspective view of a prior art hand-held light wand in use, a prior art hand-held light wand is shown generally at 20.

The configuration of the hand-held light wand 20 can best be seen in FIG. 4, which is an enlarged diagrammatic perspective view of the prior art hand-held light wand identified by ARROW 4 in FIG. 3, and as such, will be discussed with reference thereto.

The prior art hand-held light wand 20 comprises a handle 22, an illuminator 24, and a collar 26. The illuminator 24 extends coaxially from the handle 22. The collar 26 is coaxially disposed between the handle 22 and the illuminator 24. The handle 22 is slender and elongated. The illuminator 24 is slender and elongated. The collar 26 is stubby.

Thus, in view of all of the above, there exists a need for a multi-function and portable device for forming separately an illuminator and a barrier and for forming in combination an illuminated barrier.

Numerous innovations for warning lights alone or in combination with traffic control devices have been provided in the prior art, which will be described below in chronological order to show advancement in the art. Even though these innovations may be suitable for the specific individual purposes to which they address, nevertheless, they differ from the embodiments of the present invention in that they do not teach a multi-function and portable device for forming separately an illuminator and a barrier and for forming in combination an illuminated barrier.

(1) U.S. Pat. No. 5,294,924 to Dydzyk.

U.S. Pat. No. 5,294,924—issued to Dydzyk on Mar. 15, 1994 in U.S. class 340 and subclass 908.1—teaches a compact and ambient-light-sensitive flashing warning light that is removably attached, to a traffic control device to alert on-coming motorists and pedestrians of a roadway condition. A photocell is connected between a light bulb and a battery voltage source so that illumination of the bulb is made dependent upon ambient light conditions. The warning light includes a tapered attachment leg that is sized to fit through a hole in the top of a conventional hollow traffic cone, so that the warning light is removably attached to the cone by friction. As an alternate embodiment, the warning light is interfaced with an adaptor bracket that is adapted to be fastened to other traffic control devices, such as a conventional wooden barricade.

(2) U.S. Pat. No. 5,521,595 to Totten et al.

U.S. Pat. No. 5,521,595—issued to Totten et al. on May 28, 1996 in U.S. class 340 and subclass 908—teaches a self- or internally powered electric strobe-type illumination beacon for use in connection with hazard-warning, navigation, or any other activity requiring the temporary placement of an illumination device. The beacon includes switch apparatus operable by rotating the top section about the bottom section enabling the repeated pulsing of a lamp apparatus for light emissions.

(3) U.S. Pat. No. 5,577,824 to Wright.

U.S. Pat. No. 5,577,824—issued to Wright on Nov. 26, 1996 in U.S. class 340 and subclass 908.1—teaches an apparatus for mounting a light-emitting device on a traffic cone. The apparatus includes a head portion for housing the light-emitting device, a power source-receiving portion in connectable electrical contact with the head portion, and a traffic cone-receiving portion. The head portion and the power source-receiving portion are disposed laterally with respect to the traffic cone-receiving portion, so that when the apparatus is mounted on a cone and a power source is received in the power source-receiving portion, the head portion and the power source-receiving portion lie laterally alongside the section of the cone received in the cone-receiving portion, and the center of gravity of the apparatus is substantially coincident with the longitudinal axis of the cone.

(4) U.S. Pat. No. 5,585,783 to Hall.

U.S. Pat. No. 5,585,783—issued to Hall on Dec. 17, 1996 in U.S. class 340 and subclass 473—teaches a marker light device including a bendable printed circuit board, a group of light emitting diodes disposed on the bendable printed circuit board and electrically connected thereto, and a power source electrically connected to the bendable printed circuit board, thereby causing the illumination of the group of light emitting diodes. The bendable printed circuit board includes an electronic circuit for intermittently turning the group of light emitting diodes on and off at a predetermined time interval to provide a flashing light. The bendable printed circuit board, when folded so that the opposite ends thereof substantially meet, includes two panels so that the group of light emitting diodes disposed on the first panel faces in a direction generally opposite to the group of light emitting diodes disposed on the second panel, whereby the light emitting diodes project light in substantially parallel beams.

(5) U.S. Pat. No. 5,755,174 to Freeman.

U.S. Pat. No. 5,755,174—issued to Freeman on May 26, 1998 in U.S. class 116 and subclass 63 C—teaches a traffic safety control security system. Warning lights, signs, and warning flags are connected and secured to the tops of standard traffic cones, either with or without the use of cone adapters. One end of a stainless steel aircraft cable connects directly to the traffic control accessories, while the other end of the cable is secured by a removable security disc and padlock within the traffic cone. Interconnecting the accessory and the traffic cone together prevents injury to vehicles or individuals nearby if a traffic cone is accidentally struck by a vehicle or encounters violent weather causing the accessory to fly loose as a projectile. In addition, a chain interconnects traffic cones in the system together.

(6) U.S. Pat. No. 6,305,312 B1 to Bent et al.

U.S. Pat. No. 6,305,312 B1—issued to Bent el al. on Oct. 23, 2001 in U.S. class 116 and subclass 63 P—teaches a flat panel vertical traffic channelizer including front and back generally rectangular panels connected to generally triangular end panels by curved corners. Each of the curved corners is formed as a portion of a cone with a gradually increasing radius from top to bottom. The curved corners are, preferably, of a shape that would form a cone if the rectangular panels and triangular end panels were removed. Alternatively, the end panels are reduced or omitted, so that the flat panels are connected by curved corners that have a radius that gradually increases from the top to the bottom of the channelizer.

(7) U.S. Pat. No. 6,556,147 B1 to Fisher et al.

U.S. Pat. No. 6,556,147 B1—issued to Fisher et al. on Apr. 29, 2003 in U.S. class 340 and subclass 908—teaches a safety marker pylon including a hollow element composed of a translucent material, and having a lower end, a base that is connected with the hollow element by snugly fitting the lower end of the hollow element on a portion of the base, a light source with a power source arranged on the base and providing internal illumination of the hollow element, so that light is emitted through walls of the hollow element, and switch apparatus for controlling power of the power source. The base is connected removably with the lower end of the hollow element, so that the hollow element is removed from the base by pulling the hollow element upwardly from the base, and thereby in the event if the hollow element is damaged and if it is necessary to recharge the power source, upon removal of the hollow element, the base is connected with another hollow element if the first mentioned hollow element is damaged or the base is connected with a charging source to recharge the power source.

(8) U.S. Pat. No. 6,753,762 B1 to Jorba Gonzalez.

U.S. Pat. No. 6,753,762 B1—issued to Jorba Gonzalez on Jun. 22, 2004 in U.S. class 340 and subclass 333—teaches a signaling beacon including a lighting indicator that is mounted in a body enabling the stacking thereof. An energy accumulation device, at least one photovoltaic cell, and an electronic device of the beacon are in the beacon. The electronic device has a radio frequency receiver circuit to receive radio communication signals that are emitted by an emitter circuit, and a light indicator control circuit. The light indicator control circuit includes a timer, a logic circuit intending to the polarization of the timer and of the light indicator, and a connection device for switching off the energy accumulation device when the beacons are piled up. The signaling beacon is remotely controllable.

It is apparent that numerous innovations for warning lights alone or in combination with traffic control devices have been provided in the prior art, which are adapted to be used. Furthermore, even though these innovations may be suitable for the specific individual purposes to which they address, nevertheless, they would not be suitable for the purposes of the embodiments of the present invention as heretofore described, namely, a multi-function and portable device for forming separately an illuminator and a barrier and for forming in combination an illuminated barrier.

### 2. SUMMARY OF THE INVENTION

Thus, it is an object of the embodiments of the present invention to provide a multi-function and portable device for forming separately an illuminator and a barrier and for forming in combination an illuminated barrier, which avoids the disadvantages of the prior art.

Briefly stated, another object of the embodiments of the present invention is to provide a multi-function and portable device forming separately an illuminator and a barrier and forming in combination an illuminated barrier. The multi-function and portable device includes a traffic cone and a hand-held light wand. The hand-held light wand extends replaceably from the traffic cone without a need for cone adaptors so as to allow the hand-held light wand and the traffic cone to operate separately of each other and act as the illuminator and the barrier, respectively, and to act in combination with each other so as to form the illuminated barrier.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying figures of the drawing.

### 3. BRIEF DESCRIPTION OF THE FIGURES OF THE DRAWING

The figures of the drawing are briefly described as follows:

FIG. 1 is a diagrammatic perspective view of prior art traffic cones in use forming a barrier;

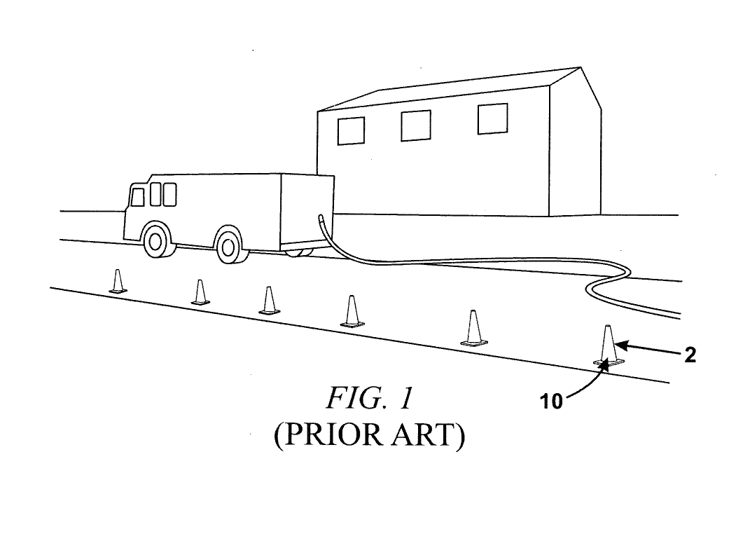

FIG. 2 is an enlarged diagrammatic perspective view of a prior art traffic cone identified by ARROW 2 in FIG. 1;

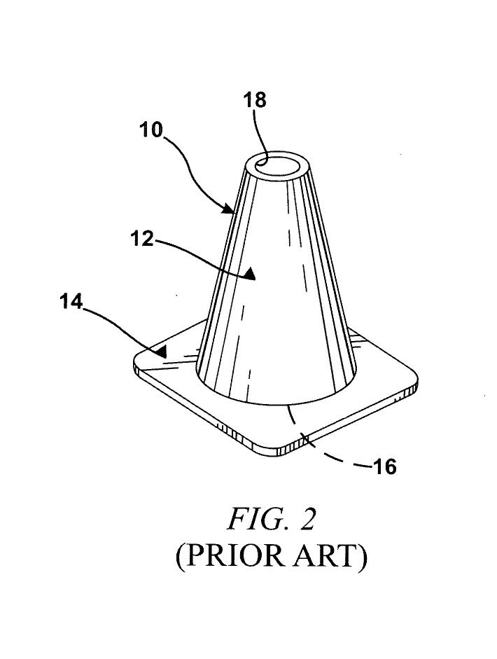

FIG. 3 is a diagrammatic perspective view of a prior art hand-held light wand in use;

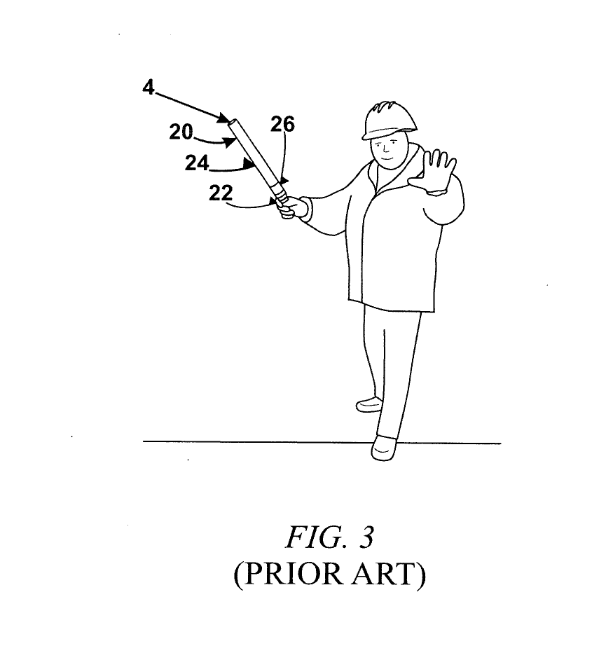

FIG. 4 is an enlarged diagrammatic perspective view of the prior art hand-held light wand identified by ARROW 4 in FIG. 3;

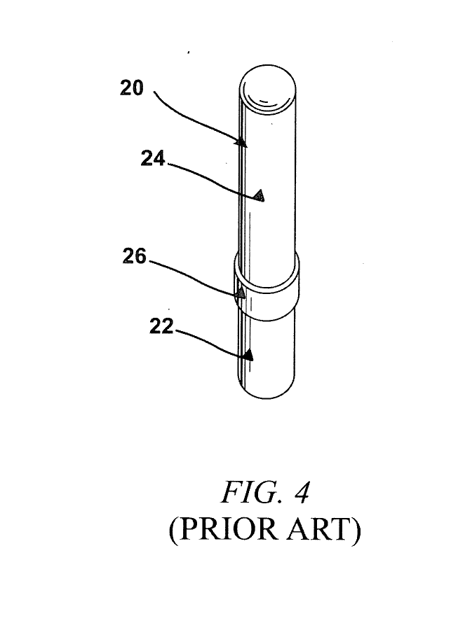

FIG. 5 is a diagrammatic perspective view of multi-function and portable devices of the embodiments of the present invention forming separately an illuminator and a barrier and forming in combination an illuminated barrier;

FIG. 6 is an enlarged diagrammatic perspective view of a multi-function and portable device of the embodiments of the present invention identified by ARROW 6 in FIG. 5; and

FIG. 7 is an exploded diagrammatic perspective view of the multi-function and portable device of the embodiments of the present invention shown in FIG. 6.

### 4. LIST OF REFERENCE NUMERALS UTILIZED IN THE FIGURES OF THE DRAWING

A. Prior Art.
10 prior art traffic cone
12 conical body of prior art traffic cone 10
14 base of prior art traffic cone 10
16 open bottom of conical body 12 of prior art traffic cone 10
18 open top of conical body 12 of prior art traffic cone 10
20 prior art hand-held light wand
22 handle of prior art hand-held light wand 20
24 illuminator of prior art hand-held light wand 20
26 collar of prior art hand-held light wand 20

B. Introductory.
30 multi-function and portable device of embodiments of present invention for forming separately illuminator 32 and barrier 34 and for forming in combination illuminated barrier 36
32 illuminator
34 barrier
36 illuminated barrier

C. Overall Configuration of Multi-function and Portable Device 30.
38 traffic cone of barrier 34
40 hand-held light wand of illuminator 32

(1) Specific Configuration of traffic Cone 38.
42 conical body
44 base
46 open bottom of conical body 42
48 open top of conical body 42

(2) Specific Configuration of Hand-held Light Wand 40.
50 handle
52 illuminating portion
54 collar
56 power source interface for containing at least one battery 57 for powering illuminating portion 52
57 at least one battery for powering illuminating portion 52
58 at least one bulb of illuminating portion 52
60 at least one LED of illuminating portion 52
62 switch
64 3 way switch of switch 62

### 5. DETAILED DESCRIPTION OF THE PREFERRED EMBODIMENTS

A. Introductory.

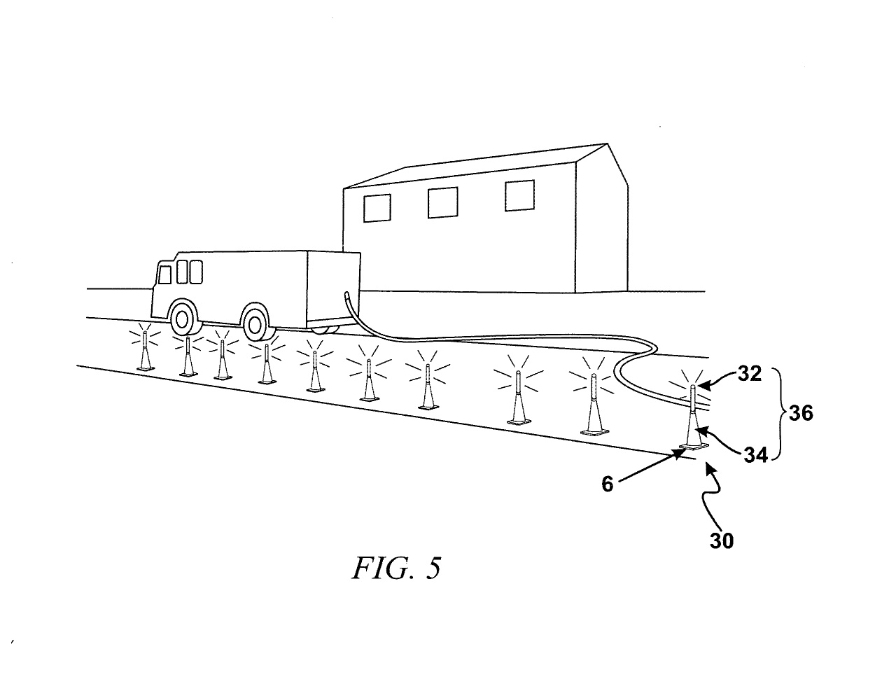

Referring now to FIG. 5, which is a diagrammatic perspective view of the multi-function and portable device of the embodiments of the present invention forming separately an illuminator and a barrier and forming in combination an illuminated barrier, the multi-function and portable device of the embodiments of the present invention is shown generally at 30 for forming separately an illuminator 32 and a barrier 34 and for forming in combination an illuminated barrier 36.

B. Overall Configuration of the Multi-function and Portable Device 30.

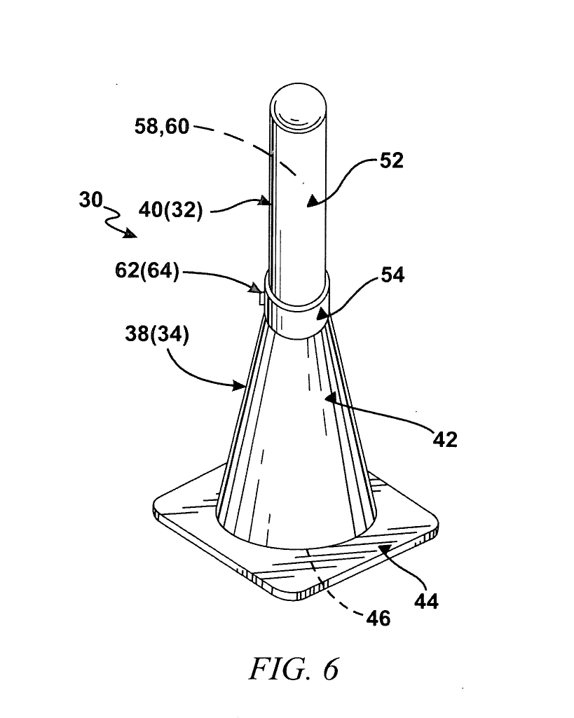

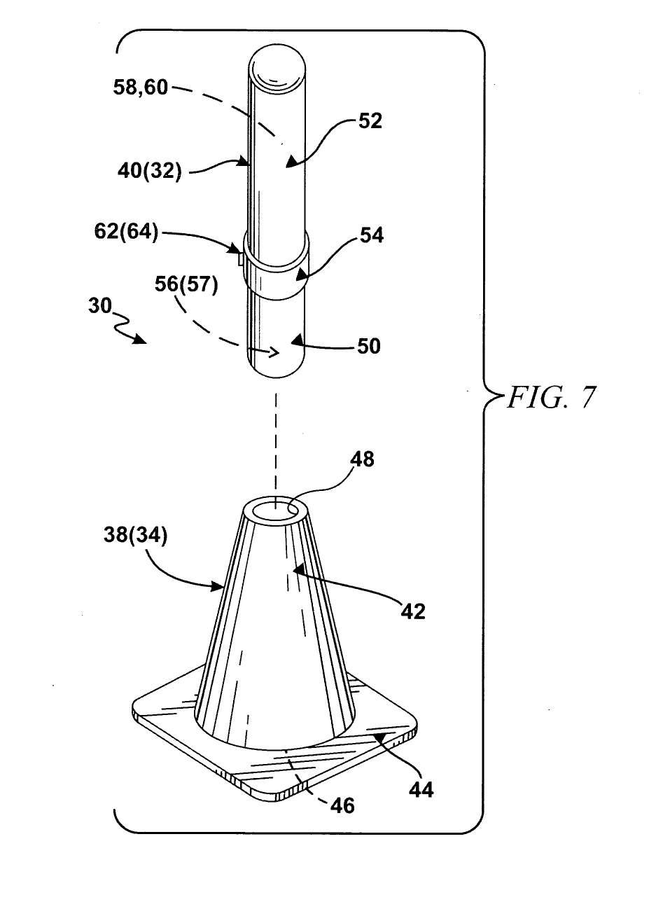

The overall configuration of the multi-function and portable device 30 can best be seen in FIGS. 6 and 7, which are, respectively, an enlarged diagrammatic perspective view of a multi-function and portable device of the embodiments of the present invention identified by ARROW 6 in FIG. 5, and an exploded diagrammatic perspective view of the multi-function and portable device of the embodiments of the present invention shown in FIG. 6, and as such, will be discussed with reference thereto.

The multi-function and portable device 30 comprises a traffic cone 38 and a hand-held light wand 40. The hand-held light wand 40 extends replaceably from the traffic cone 38 without a need for cone adaptors so as to allow the hand-held light wand 40 and the traffic cone 38 to operate separately of each other and act as the illuminator 32 and the barrier 34, respectively, and to act in combination with each other so as to form the illuminated barrier 36.

The hand-held light wand 40 extends coaxially from the traffic cone 38.

(1) Specific Configuration of the Traffic Cone 38.

The traffic cone 38 comprises a conical body 42 and a base 44. The conical body 42 of the traffic cone 38 extends upwardly from the base 44 of the traffic cone 38, is hollow, is upwardly tapering, has an open bottom 46 so as to be stackable and an open top 48, and may display light-reflective material. The base 44 of the traffic cone 38 is flat, and extends radially outwardly from the open bottom 46 of the conical body 42 of the traffic cone 38.

(2) Specific Configuration of the Hand-held Light Wand 40.

The hand-held light wand 40 comprises a handle 50, an illuminating portion 52, and a collar 54. The illuminating portion 52 of the hand-held light wand 40 extends coaxially from the handle 50 of the hand-held light wand 40. The collar 54 of the hand-held light wand 40 is coaxially disposed between the handle 50 of the hand-held light wand 40 and the illuminating portion 52 of the hand-held light wand 40. The handle 50 of the hand-held light wand 40 is slender and elongated. The illuminating portion 52 of the hand-held light wand 40 is slender, elongated, translucent, and has 360° of visibility. The collar 54 of the hand-held light wand 40 is stubby.

The handle 50 of the hand-held light wand 40 is sized to fit coaxially through the open top 48 of the conical body 42 of the traffic cone 38 so as to allow the hand-held light wand 40 to be replaceably attached to the traffic cone 38 by friction.

The hand-held light wand 40 further comprises a power source interface 56.

The power source interface 56 of the hand-held light wand 40 is disposed in the handle 50 of the hand-held light wand 40, electrically communicates with the illuminating portion 52 of the hand-held light wand 40, and is for containing at least one battery 57 for powering the illuminating portion 52 of the hand-held light wand 40.

The collar 54 of the hand-held light wand 40 forms a stop for how far the handle 50 of the hand-held light wand 40 goes into the open top 48 of the conical body 42 of the traffic cone 38.

The illuminating portion 52 of the hand-held light wand 40 contains at least one bulb 58 and/or at least one LED 60.

The hand-held light wand 40 further comprises a switch 62.

The switch 62 of the hand-held light wand 40 is disposed at the collar 54 of the hand-held light wand 40, and is a 3 way switch 64.

The 3 way switch 64 of the switch 62 of the hand-held light wand 40 has on, off, and flashing/strobe positions.

C. Impressions.

It will be understood that each of the elements described above or two or more together may also find a useful application in other types of constructions differing from the types described above.

While the embodiments of the present invention have been illustrated and described as embodied in a multi-function and portable device for forming separately an illuminator and a barrier and for forming in combination an illuminated barrier, nevertheless, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features from the standpoint of prior art fairly constitute characteristics of the generic or specific aspects of the embodiments of the present invention.

The invention claimed is:

1. A multi-function and portable device for forming separately an illuminator and a barrier and for forming in combination an illuminated barrier, comprising:
a) a traffic cone; and
b) a hand-held light wand;
wherein said hand-held light wand extends replaceably from said traffic cone without a need for cone adaptors so as to allow said hand-held light wand and said traffic cone to operate separately of each other and act as said illuminator and said barrier, respectively, and to act in combination with each other so as to form said illuminated barrier.

2. The multi-function and portable device of claim 1, wherein said hand-held light wand extends coaxially from said traffic cone.

3. The multi-function and portable device of claim 1, wherein said traffic cone comprises a conical body.

4. The multi-function and portable device of claim 3, wherein said traffic cone comprises a base.

5. The multi-function and portable device of claim 4, wherein said conical body of said traffic cone extends upwardly from said base of said traffic cone.

6. The multi-function and portable device of claim 3, wherein said conical body of said traffic cone is hollow.

7. The multi-function and portable device of claim 3, wherein said conical body of said traffic cone is upwardly tapering.

8. The multi-function and portable device of claim 4, wherein said conical body of said traffic cone has an open bottom so as to be stackable.

9. The multi-function and portable device of claim 3, wherein said conical body of said traffic cone has an open top.

10. The multi-function and portable device of claim 4, wherein said base of said traffic cone is flat.

11. The multi-function and portable device of claim 8, wherein said base of said traffic cone extends radially outwardly from said open bottom of said conical body of said traffic cone.

12. The multi-function and portable device of claim 9, wherein said hand-held light wand comprises a handle.

13. The multi-function and portable device of claim 12, wherein said hand-held light wand comprises an illuminating portion.

14. The multi-function and portable device of claim 13, wherein said hand-held light wand comprises a collar.

15. The multi-function and portable device of claim 13, wherein said illuminating portion of said hand-held light wand extends coaxially from said handle of said hand-held light wand.

16. The multi-function and portable device of claim 14, wherein said collar of said hand-held light wand is coaxially disposed between said handle of said hand-held light wand and said illuminating portion of said hand-held light wand.

17. The multi-function and portable device of claim 12, wherein said handle of said hand-held light wand is slender.

18. The multi-function and portable device of claim 12, wherein said handle of said hand-held light wand is elongated.

19. The multi-function and portable device of claim 13, wherein said illuminating portion of said hand-held light wand is slender.

20. The multi-function and portable device of claim 13, wherein said illuminating portion of said hand-held light wand is elongated.

21. The multi-function and portable device of claim 13, wherein said illuminating portion of said hand-held light wand is translucent.

22. The multi-function and portable device of claim 14, wherein said collar of said hand-held light wand is stubby.

23. The multi-function and portable device of claim 12, wherein said handle of said hand-held light wand is sized to fit through said open top of said conical body of said traffic cone so as to allow said hand-held light wand to be replaceably attached to said traffic cone by friction.

24. The multi-function and portable device of claim 13, wherein said hand-held light wand comprises a power source interface.

25. The multi-function and portable device of claim 24, wherein said power source interface of said hand-held light wand is disposed in said handle of said hand-held light wand; and
wherein said power source interface of said hand-held light wand is for containing at least one battery for powering said illuminating portion of said hand-held light wand.

26. The multi-function and portable device of claim 24, wherein said power source interface of said hand-held light wand electrically communicates with said illuminating portion of said hand-held light wand.

27. The multi-function and portable device of claim 14, wherein said collar of said hand-held light wand forms a stop for how far said handle of said hand-held light wand goes into said open top of said conical body of said traffic cone.

28. The multi-function and portable device of claim 13, wherein said illuminating portion of said hand-held light wand contains at least one bulb.

29. The multi-function and portable device of claim 13, wherein said illuminating portion of said hand-held light wand contains at least one LED.

30. The multi-function and portable device of claim 14, wherein said hand-held light wand comprises a switch.

31. The multi-function and portable device of claim 30, wherein said switch of said hand-held light wand is disposed at said collar of said hand-held light wand.

32. The multi-function and portable device of claim 30, wherein said switch of said hand-held light wand is a 3 way switch.

33. The multi-function and portable device of claim 32, wherein said 3 way switch of said switch of said hand-held light wand has on, off, and flashing/strobe positions.

34. The multi-function and portable device of claim 3, wherein said conical body of said traffic cone displays light-reflective material.

35. The multi-function and portable device of claim 13, wherein said illuminating portion of said hand-held light wand has 360° of visibility.
